(19) United States
(12) Patent Application Publication
(10) Pub. No.: US 2007/0006710 A1
(43) Pub. Date: Jan. 11, 2007

(54) GUITAR

(76) Inventor: Cheng Chung CHEN, Sijhih City, Taipei County (TW)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/426,327

(22) Filed: Jun. 26, 2006

(30) Foreign Application Priority Data
Jul. 8, 2005 (TW) 94123140

(51) Int. Cl. G10D 3/00

(52) U.S. Cl. 84/291

(57) ABSTRACT

The present invention relates to a guitar comprising a resonant cavity, a fretboard, a headstock and a neck, of which the fretboard is provided between the resonant cavity and the headstock, the neck is fixed at one side of the resonant cavity, and the fretboard extends to the lower portion of the resonant cavity; a first fretboard portion of the fretboard has a width adapted to receive a plurality of strings, and a second fretboard portion of the fretboard has a width adapted to receive the plurality of strings and a treble string; there is a first hole in a position where the second fretboard portion joins the first fretboard portion, and there is a second hole in the headstock near the first fretboard portion; the neck has a groove which is formed between the first hole and the second hole, and through which the treble string provided on the second fretboard portion enters the first hole and exits from the second hole to be wound to a peghead at the headstock.

### RELATED APPLICATION

The present application claims the benefit of Taiwanese Patent Application No. 94123140 filed on Jul. 8, 2005, which is incorporated herein by entirety by reference.

### FIELD OF THE INVENTION

The present invention relates to a guitar, and more particularly, a guitar capable of adding treble strings and/or bass strings thereon.

### BACKGROUND TO THE INVENTION

A general classical guitar (hereinafter also referred to as a conventional guitar) has six strings provided on the fretboard extending from the neck to the sound hole of the resonant cavity. The notes of the six strings are “E,,”, “A,,”, “D,”, “G,”, “B,” and “E”, respectively. It is to be noted that “E” is a musical alphabet and corresponds to the middle E of a piano, “E,” denotes a note one octave lower than the middle E, “E,,” denotes a note two octaves lower than the middle E, “E′” denotes a note one octave higher than the middle E, “E″” denotes a note two octaves higher than the middle E, and so on. Generally, a classical guitar is such designed that frets after the twelfth fret are all located on the resonant cavity (also called as body) of the guitar, and thus when playing either chords or single notes, interruptions will occur and affect the presentation of good acoustics.

As for the increase of a guitar's range and/or the improvement of playing the guitar at high range, which have been concerned with all the times and tried continuously, the common ways nowadays are described below:

(1) Cut-Away Type Guitar

A cut-away type guitar is such structured that the resonant cavity is shaped to have a cut corner and thus about 5 frets can be further provided after the twelfth fret on which the strings are difficult to be pressed. With such a structure, the strings can be easily pressed, and the high range which can be easily played is increased by about four intervals. However, the drawback thereof is that the size of the resonant cavity must be reduced to a non-arc structure that is poor in resonant effect. Meanwhile, although about 5 frets (about four intervals) on which the strings can be easily pressed are further provided on the lower portion, yet for a player's playing on higher finger positions (such as the finger position above the seventh finger position), the chance for obtaining a buffer for the left hand's plucking by using open string is less. Especially, when changing the finger position, the difficulty of pressing on the higher finger position is increased; if it is forced to apply open string, there will be inharmonious with the timbre of high finger positions, except that a solid and bright timbre of open string is to be expressed intentionally.

(2) Multi-String Guitar Such as 7-String, 8-String or 10-String Guitar

The main effectiveness of a multi-string guitar is to make the tone quality of the guitar purer and thicker and the bass range expended toward lower range by the resonant effect of the additional bass strings. However, due to the limit of the guitar's range, the actual tones as played are one octave lower than written on the score so that a bright timbre at higher range can not be produced and thus the guitar is still imperfect.

In view of a multi-string guitar which is further provided with treble strings thereon, for example, a 7-string guitar has the notes of “E,,”, “A,,”, “D,”, “G,”, “B,”, “E” and “A” in turn from the bass, which further comprises a treble string “A” having a tone fourth interval higher in comparison with a conventional guitar. Although the range thereof expands upwardly by four intervals, yet it is difficult for a player skilled in playing a conventional 6-string guitar to play existing music smoothly, and thus there is a poor compatibility in playing between the 7-string guitar and the conventional 6-string guitar. It is also obvious that the compatibility of playing technique between an 8-string guitar, which is further provided with two treble strings thereon for example, and the conventional 6-string guitar is worse.

(3) Alto Cembalo Guitar

An Alto Cembalo guitar has a body smaller than that of a general classical guitar, a higher tone by a fifth interval and a brighter timbre, and plays a treble role in a guitar ensemble. However, as a solo instrument, the Alto Cembalo guitar fails to present the original feel of conventional guitar music with its own tonality, has a smaller volume, and lacks a purer and thicker tone quality as of a conventional classical guitar.

In order to overcome the above-mentioned drawbacks, the inventor's Taiwanese Patent Application No. 93135534 of “Guitar with improvement on fretboard structure,” which was laid open on Apr. 1, 2005 under Laid-open No. 200512715, has made a certain modification on a guitar's fretboard structure at the side where treble strings are provided, in which the pegheads are made to be hidden and the knobs for rotating the worms are made to be separable from the worms.

Accordingly, not only the guitar's range can expend upwardly by at least a third interval, but also the frets at high range, even the fret having the highest tone, can be easily pressed, so that the effective range which can be easily played can completely cover four octaves or more, and treble music that are difficult to be played and are played with poor sound quality for a conventional guitar can be played with good sound quality. Especially, by setting the tones of the strings on the additional stepped fretboard, a player can play the guitar by continuing using the existing fingering and technique for conventional guitars (perhaps minor modification shall be merely made thereon). The player can also ignore the existence of the additional fretboard and the strings thereon and use the guitar as a conventional guitar to perform.

However, the guitar as described in the above-mentioned patent application is such structured that the neck needs to have a space dug on the back side thereof for providing the pegheads, which is space-consuming, and thus the guitar is difficult to be manufactured. Meanwhile, the knobs for tuning the strings are made to be separable from the worms of the pegheads, which connect the worms when tuning the strings; therefore, the guitar cannot be fine tuned (namely, tuning the strings) during the short break of a performance and thus has not arrived at an ideal level yet.

### SUMMARY OF THE INVENTION

Based on the inventor's Taiwanese Patent Application No. 93135534 of “Guitar with improvement on fretboard structure,” which was laid open on Apr. 1, 2005 under Laid-open No. 200512715, the object of the present invention is to provide a guitar, making a further improvement on the fretboard structure in a manner that the space of fretboard and neck will not be occupied and the guitar can be easily fabricated so that in addition to retaining the compatibility to conventional guitars, the guitar can be further expanded to higher range. Meanwhile, the resonant cavity thereof is also improved so as to meet the ergonomics and facilitate the easiness of pressing the strings upon playing the guitar at high range for better expression of music. Moreover, frets are further provided or bass strings are added at the same time so as to greatly expand the guitar's range. Therefore, the present invention is very effective in increasing the performance of guitar such as easily playing and expanding the range. With the present invention, the guitar music can be expected to explore a new era.

The present invention provides a guitar comprising a resonant cavity, a fretboard, a headstock and a neck, of which the fretboard is provided between the resonant cavity and the headstock, a plurality of strings provided on the fretboard are wound to pegheads which are provided on the headstock for tuning the strings, the neck is fixed at one side of the resonant cavity, and the fretboard extends to the lower portion of the resonant cavity, characterized in that a first fretboard portion of the fretboard has a width adapted to receive a plurality of strings, and a second fretboard portion of the fretboard has a width adapted to receive the plurality of strings and a treble string; there is a first hole in a position where the second fretboard portion joins the first fretboard portion, and there is a second hole in the first fretboard portion near the pegheads; the neck has a groove which is formed between the first hole and the second hole, and through which the treble string provided on the second fretboard portion enters the first hole and exits from the second hole to be wound to a peghead.

It is preferable for the guitar of the present invention that the resonant cavity has an arc surface formed at the side where the fretboard is provided, for reducing the interference with the left hand upon pressing the strings.

It is more preferable for the guitar of the present invention that the fretboard extends a plurality of frets from the sound hole of the resonant cavity.

It is still more preferable for the guitar of the present invention that the fretboard is widened to be further provided with a bass string thereon at the other side opposite to the side where the treble string is provided.

### BRIEF DESCRIPTION OF THE DRAWINGS

The structure of the present invention will now be described by referring to the accompanying drawings, in which:

FIG. 1 is a schematic view showing the appearance of a guitar according to the present invention;

FIG. 2 is a schematic view showing a partial appearance of the guitar according to the present invention;

FIG. 3 is a schematic view showing the fretboard and the neck of the guitar according to the present invention;

FIG. 4 is a sectional view showing the fretboard and the neck, taken from line 4-4 in FIG. 3; and

FIG. 5 is a schematic view showing the appearance of another guitar according to the present invention.

### DESCRIPTION OF PREFERRED EMBODIMENTS

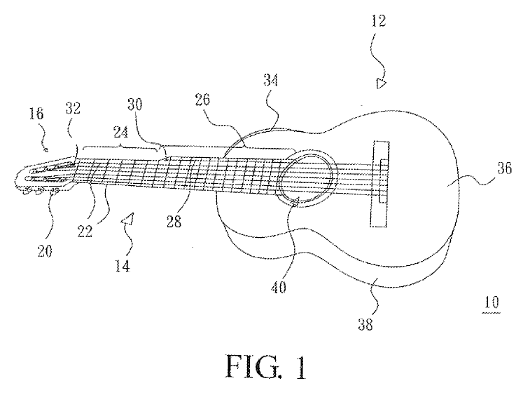

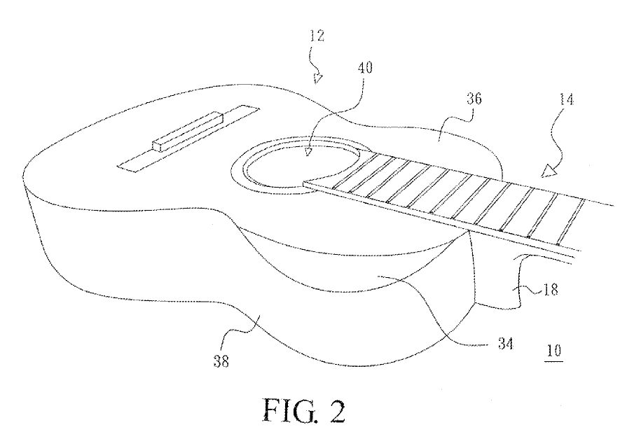

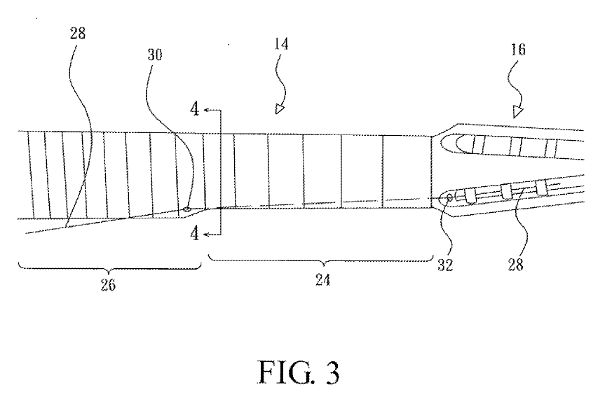

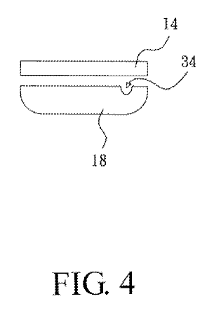

FIG. 1 is a schematic view showing the appearance of a guitar according to the present invention; FIG. 2 is a schematic view showing a partial appearance of the guitar according to the present invention; FIG. 3 is a schematic view showing the fretboard and the neck of the guitar according to the present invention; and FIG. 4 is a sectional view showing the fretboard and the neck, taken from line 4-4 in FIG. 3. The structure of a guitar of the present invention will now be described by referring to FIG. 1 to FIG. 4.

One embodiment of the guitar according to the present invention comprises a resonant cavity 12, a fretboard 14, a headstock 16 and a neck 18, of which the fretboard 14 is provided between the resonant cavity 12 and the headstock 16, six strings 22 (a conventional guitar is taken for example here) provided on the fretboard 14 are wound to pegheads 20 which are provided on the headstock 16 for tuning the six strings 22, the neck 18 is fixed on one side of the resonant cavity 12, and the fretboard 14 extends to the lower portion of the resonant cavity 12.

A first fretboard portion 24 of the fretboard 14 has a width adapted to receive the six strings 22, and a second fretboard portion 26 of the fretboard 14 has a width adapted to receive the six strings 22 and a treble string 28. There is a first hole 30 in a position where the second fretboard portion 26 joins the first fretboard portion 24, and there is a second hole 32 in the headstock 16 near the first fretboard portion 24. The neck 18 has a groove 34 which is formed between the first hole 30 and the second hole 32, and through which the treble string 28 provided on the second fretboard portion 26 enters the first hole 30 and exits from the second hole 32 to be wound to a peghead 20.

The notes of open strings of the guitar 10 having the treble string 28 provided on the fretboard 14 thereof are “E,,”, “A,,”, “D,”, “G,”, “B,”, “E” and “E′”, respectively. It is to be noted that “E” is a musical alphabet and corresponds to the middle E of a piano, “E,” denotes a note one octave lower than the middle E, “E,,” denotes a note two octaves lower than the middle E, “E′” denotes a note one octave higher than the middle E, “E″” denotes a note two octaves higher than the middle E, and so on. The highest note is E″, and the total range of the guitar 10 from the most bass string to the most treble string covers 4 octaves.

Further, the resonant cavity 12 has an arc surface 34 formed at the side where the fretboard 14 is provided, for reducing the interference with the left hand upon pressing the strings. The arc surface 34 can be integrally formed with an upper flat surface 36 of the resonant cavity 12, or can be a single arc plate formed between the upper flat surface 36 and a side surface 38 of the resonant cavity 12.

The above-mentioned guitar is structured by making an improvement on a conventional guitar (6 strings/19 frets) to form such a structure of the fretboard 14 and the resonant cavity adapted to ergonomics. In addition that the strings on the twelfth to the nineteenth frets are easily pressed, the range is expanded toward high range by a fourth interval due to the additional string. Meanwhile, because the fretboard 14 is structured to extend toward the high range side from the seventh fret so that the additional string can be easily neglected upon playing the guitar and existing music as composed or arranged can be played with the fingering of conventional guitar; therefore, there is a very high compatibility in playing between the present guitar and a conventional guitar. Surely, upon playing the guitar at high range, properly using the additional string can not only facilitate the performance of music but also express the music with different treatments to expand the possibility of playing the guitar 10.

Another embodiment of the guitar according to the present invention is described below.

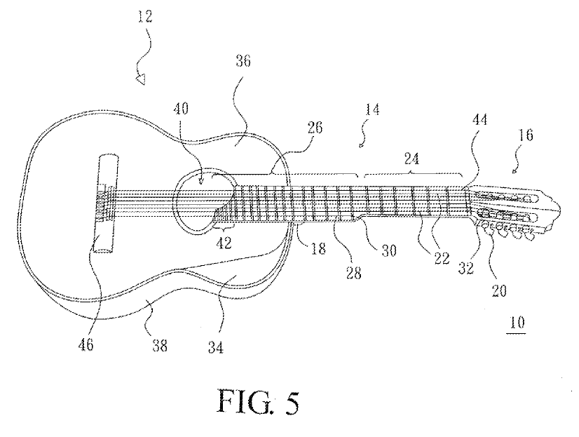

As shown in FIG. 5, the fretboard 14 of the guitar of the above-mentioned embodiment is such modified that there is a plurality of frets 42 (the twentieth fret to the twenty-fourth fret) additionally extended from the sound hole 40 of the resonant cavity 12. Because the extended frets 42 are located on a portion of the sound hole 40, the shape of the sound hole 40 is thus changed somewhat as a heart-shaped opening to match the extended frets 42 so that the whole sound hole 40 will not move toward the bridge 46 too much. It is believed that such a design can produce better sound effects. Meanwhile, the fretboard 14 is widened to be further provided with a bass string 44 thereon at the other side opposite to the side where the treble string 28 is provided so that the range of the guitar 10 can be greatly increased.

The notes of the open strings of the guitar 10 having the additional frets and the bass string 44 provided on the fretboard 14 thereof are “C,,”, “E,,”, “A,,”, “D,”, “G,”, “B,”, “E” and “E′” (the same musical alphabets as described above), respectively. The highest tone is “A″”, and the total range of the guitar 10 from the most bass string to the most treble string covers 4 octaves plus a sixth interval. In addition to the advantages of the structure of the above-mentioned guitar that the resonant cavity 12 and the fretboard 14 are improved for adding a treble string 28, because there are totally 24 frets and a bass string 44 (having a tone of “C,,” in this embodiment) is further provided, the total range thereof is more than that of a conventional guitar by a ninth interval (a second interval toward low range and a seventh interval toward high range). Therefore, in addition to the compatibility between the present guitar and the conventional guitar and the characteristic that the strings at high range can be easily pressed, the broad range can greatly increase the expression upon playing the guitar 10.

While the present invention has been described above with reference to the preferred embodiments and the illustrative drawings, it should not be considered as limited thereby. Various possible modifications, omissions, and alterations could be conceived of by one skilled in the art to the form and the content of any particular embodiment, without departing from the scope of the present invention.

What is claimed is:

1. A guitar comprising a resonant cavity, a fretboard, a headstock and a neck, of which the fretboard is provided between the resonant cavity and the headstock, a plurality of strings provided on the fretboard are wound to pegheads which are provided on the headstock for tuning the strings, the neck is fixed at one side of the resonant cavity, and the fretboard extends to the lower portion of the resonant cavity, characterized in that:
a first fretboard portion of the fretboard has a width adapted to receive a plurality of strings, and a second fretboard portion of the fretboard has a width adapted to receive the plurality of strings and a treble string; there is a first hole in a position where the second fretboard portion joins the first fretboard portion, and there is a second hole in the headstock near the first fretboard portion; the neck has a groove which is formed between the first hole and the second hole, and through which the treble string provided on the second fretboard portion enters the first hole and exits from the second hole to be wound to a peghead.

2. The guitar according to claim 1, wherein the resonant cavity has an arc surface formed at the side where the fretboard is provided, for reducing the interference with the left hand upon pressing the strings.

3. The guitar according to claim 2, wherein the arc surface is integrally formed with an upper flat surface of the resonant cavity, or is a single arc plate formed between the upper flat surface and a side surface of the resonant cavity.

4. The guitar according to claim 1 or 2, wherein the fretboard extends a plurality of frets from the sound hole of the resonant cavity.

5. The guitar according to claim 1 or 2, wherein the fretboard is widened to be further provided with a bass string thereon at the other side opposite to the side where the treble string is provided.
